(19) United States
(12) Patent Application Publication
(10) Pub. No.: US 2018/0143088 A1
(43) Pub. Date: May 24, 2018

(54) METHOD OF IMPROVING THE FIT BETWEEN MATING SURFACES UTILIZING A THIN AND FLEXIBLE SENSOR

(71) Applicant: FORD MOTOR COMPANY, Dearborn, MI (US)

(72) Inventors: Hossein Jacob SADRI, Novi, MI (US); Stephen JUSZCZYK, Walled Lake, MI (US)

(21) Appl. No.: 15/356,150

(22) Filed: Nov. 18, 2016

(51) Int. Cl. G01L 1/04; B62D 65/06

(52) U.S. Cl. CPC G01L 1/04; B62D 65/06

(57) ABSTRACT

A method and system for measuring pressure in critical fit areas in the seal gap between a closure member and an opening defined by a vehicle. Critical contact pressure areas are identified and pressure profile data is measured across an area of surface contact in the seal gap with a thin strip-shaped electronic sensor. The electronic sensor includes a plurality of discreet pressure sensors arrayed across a sensor strip. The electronic sensor is inserted between the door and door opening while the door is “softly” closed against the seal. Pressure data may be analyzed and uploaded to a manufacturing database and control system.

### TECHNICAL FIELD

This disclosure relates to the identification of problems relating to the fit of vehicle closure members with adjacent vehicle structures utilizing thin and flexible pressure sensors.

### BACKGROUND

In vehicle assembly operations, closure members such as doors and trunk lids must be accurately assembled within a door frame, trunk opening, hood opening, or the like. When a closure member is misaligned or the closure member or the frame is out of tolerance, areas around the closure member may exert insufficient or excessive pressure on a peripheral seal. Insufficient pressure on a seal may result in a water leak or wind noise, vibration and harshness (NVH) issues. Excessive pressure on a seal may result in high effort being required to close a door.

This disclosure is directed to solving the above problems and other problems as summarized below.

### SUMMARY

According to one aspect of this disclosure, a method is disclosed for assembling a closure member to a vehicle. The first step of the method is identifying critical contact pressure areas between the closure member and a door opening. Next, pressure profile data is measured across an area of surface contact with a strip shaped electronic sensor of a length “L” between the closure member and the opening. The pressure profile data is then analyzed to create analytical data.

According to other aspects of the method, the measuring step is performed with an electronic sensor between 0.5 and 1.0 mils thick that is used to measure the pressure profile across an area of surface contact. The electronic sensor may be connected to a handle by an articulating joint, wherein an angular orientation of the sensor relative to the handle is adjusted to align the strip ergonomically with a seal gap defined between the closure member and the door opening defined by a vehicle when the door is closed.

The method may further comprise transmitting the pressure profile data for a plurality of critical fit areas to a data processing system and analyzing the pressure profile data for the plurality of critical fit areas. The pressure profile data may be stored for a plurality of critical fit areas on a data storage device and downloaded from the data storage device to a data processing system that analyzes the pressure profile data for the critical fit areas.

The step of measuring the pressure profile data across an area of surface contact for all critical fit areas may be performed on selected vehicles after assembly on an assembly line and the data may be recorded in a database that collects manufacturing records associated with the vehicle.

According to another aspect of this disclosure, a system is disclosed for monitoring pressure around a vehicle closure member. The system includes an electronic sensor including a plurality of discrete pressure sensors on a membrane that create a profile of pressure data. A data processor receives and analyzes the profile of pressure data to identify areas of insufficient and excessive pressure. A data storage system records the areas of insufficient and excessive pressure around the vehicle closure member.

According to other aspects of the disclosure as it relates to the system, a transmitter may be operatively connected to the electronic sensor to transmit the profile of pressure data and a receiver may be operatively connected to the data processor to receive the profile of pressure data. Alternatively, a data storage device may be operatively connected to the electronic sensor that stores the pressure profile data and a terminal may be operatively connected to the data processor that downloads the pressure profile data from the data storage device.

The electronic sensor may be a planar electronic sensor and the system may further comprise a handle attached to the planar electronic sensor by an articulated connector. The planar electronic sensor is adapted to be inserted into a seal gap defined between the closure member and a door opening defined by a vehicle to be closed by the closure member in a plurality of critical fit areas located at different locations around the closure member. The planar electronic sensor may be ergonomically adjusted relative to the handle to be aligned with the seal gap at a selected critical fit area.

The step of measuring the pressure profile data across an area of surface contact may be performed at a randomly selected subset of selected critical fit areas on each vehicle assembled on an assembly line. A database system may be utilized to collect the profile of pressure data as a manufacturing record associated with the vehicle.

The above aspects of this disclosure and other aspects will be described below with reference to the attached drawings.

### BRIEF DESCRIPTION OF THE DRAWINGS

FIG. 1 is a flowchart of the method of improving the fit between a closure member and an opening in a vehicle.

FIG. 2 is a fragmentary side elevation view of a vehicle door showing critical fit areas around the door in a seal gap defined between a door and a door opening.

FIG. 3A is a fragmentary perspective view of a vehicle with an open door showing an electronic strip-shaped sensor in position for measuring pressure profile from inside the vehicle at a critical fit area.

FIG. 3B is a fragmentary perspective view of a vehicle with a closed door showing an electronic strip-shaped sensor in position for measuring pressure profile from outside the vehicle at a critical fit area.

FIG. 4 is an elevation view of an electronic strip shaped sensor attached to an electronic pressure sensor handle.

FIG. 5 is a plan view of an electronic pressure sensor handle with an electronic strip shaped sensor attached to a handle by a articulating connector.

FIG. 6 is a perspective view of an electronic pressure sensor handle with an electronic strip shaped sensor including a transmitter that provides pressure profile data to a data processing system.

FIG. 7 is a plan view of an electronic pressure sensor handle with an electronic strip shaped sensor adapted to provide pressure profile data to a data storage device for subsequent downloading to a data processing system.

### DETAILED DESCRIPTION

The illustrated embodiments are disclosed with reference to the drawings. However, it is to be understood that the disclosed embodiments are intended to be merely examples that may be embodied in various and alternative forms. The figures are not necessarily to scale and some features may be exaggerated or minimized to show details of particular components. The specific structural and functional details disclosed are not to be interpreted as limiting, but as a representative basis for teaching one skilled in the art how to practice the disclosed concepts.

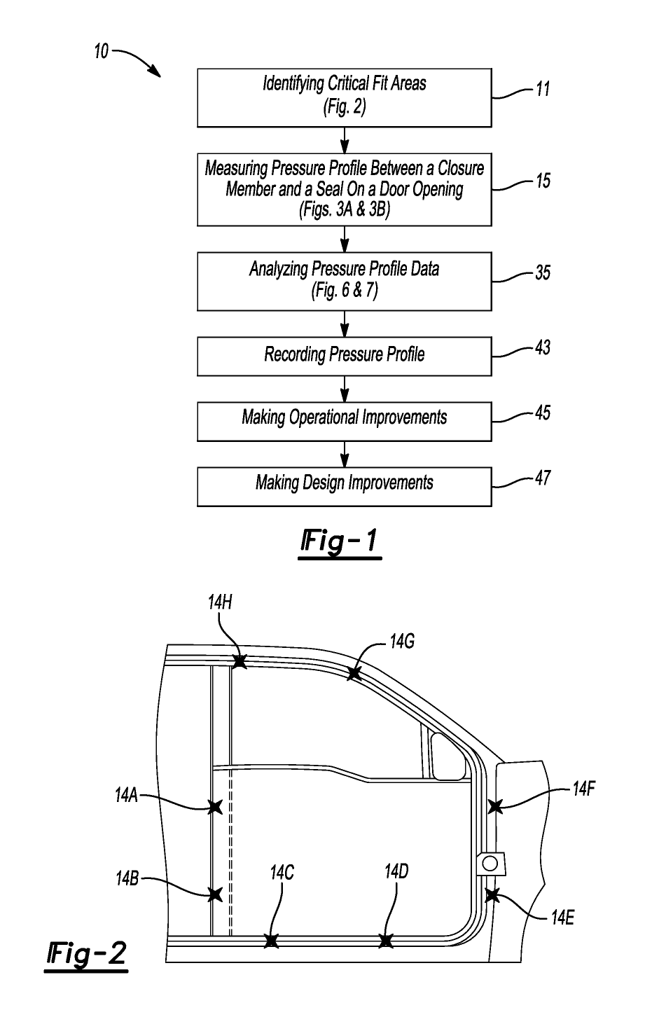

Referring to FIG. 1, a method of measuring pressure in critical fit areas in the seal gap between a closure member and an opening defined by a vehicle is illustrated by a flowchart generally indicated by reference numeral 10.

Referring to FIGS. 1 and 2, identifying critical fit areas is the first step shown in the flowchart 10 and is identified by reference numeral 11. Examples of critical fit areas shown in FIG. 2 include the following seal gap locations:

14A—B-pillar at handle;

14B—lower B-pillar;

14C—rear rocker panel;

14D—front rocker panel;

14E—lower hinge pillar;

14F—upper hinge pillar;

14G—upper A-pillar; and

14H—roof rail at B-pillar.

While particular locations are illustrated in FIG. 2, it should be understood that other locations, additional locations, or fewer locations may be designated as critical fit locations depending upon considerations such as water leakage, potential wind noise, door closing effort and customer feedback. These inputs are analyzed to develop a “sweet spot” for seal pressure at the critical fit areas.

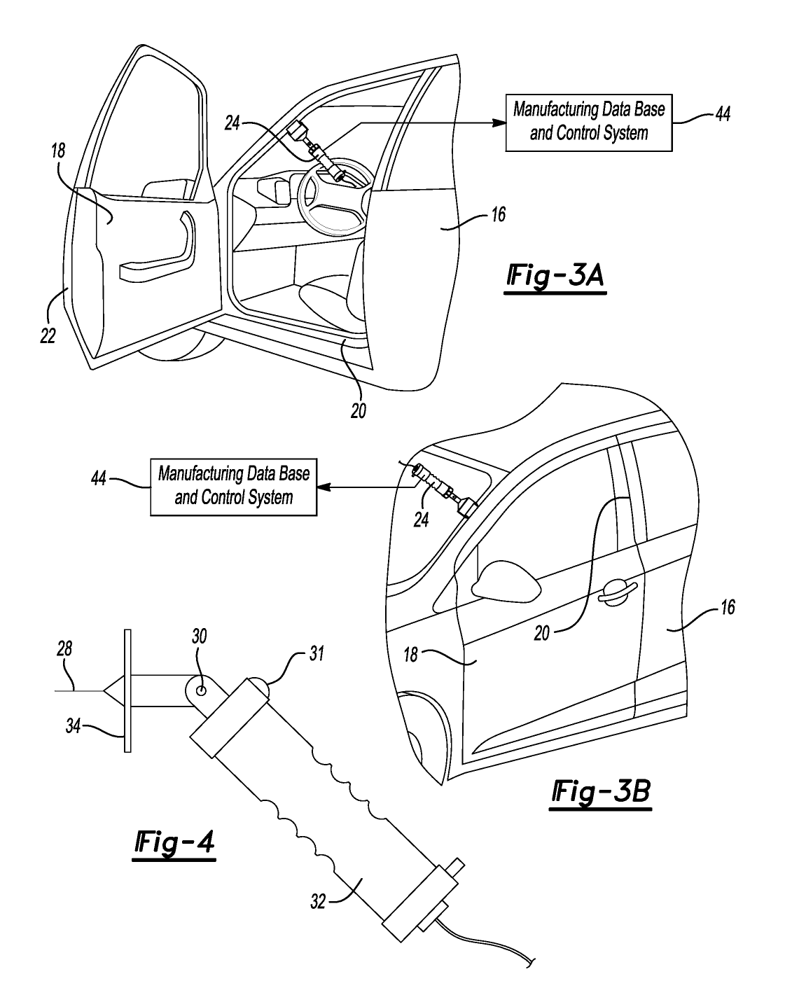

Referring to FIGS. 1, 3A and 3B, in the flowchart, at 15, the next step of the process is measuring the pressure profile between a seal on closure member and an opening. The vehicle 16 includes a door 18 that is used to close a door opening 20. Seal 22 is provided on the vehicle door 18 that is adapted to engage the door opening 20 when the door is closed as shown in FIG. 3B.

In FIGS. 3A and 3B, the vehicle door 18 is shown in an open position in FIG. 3A and is shown in a closed position in Figure in 3B. The door 18 is moved from the open position shown in 3A to a closed position shown in FIG. 3B. As the door is closed, an electronic strip pressure sensor 24 is inserted between the seal 22 and the door opening 20. The door is closed with the force of approximately 1.5 joules to reduce the impact of the seal 22 on the pressure sensor 24. 1.5 Joules corresponds to a relatively “soft” closing of the door 18.

The pressure sensor provides a measurement of the pressure exerted by the seal 22 on the door opening 20 after the door 18 is closed. The measurement may be taken from outside the vehicle 16 or from inside the vehicle 16. The measured pressure is representative of the seal pressure profile at a discreet location designated as one of the critical fit areas 14 when the door 18 is closed and the vehicle 16 is being driven.

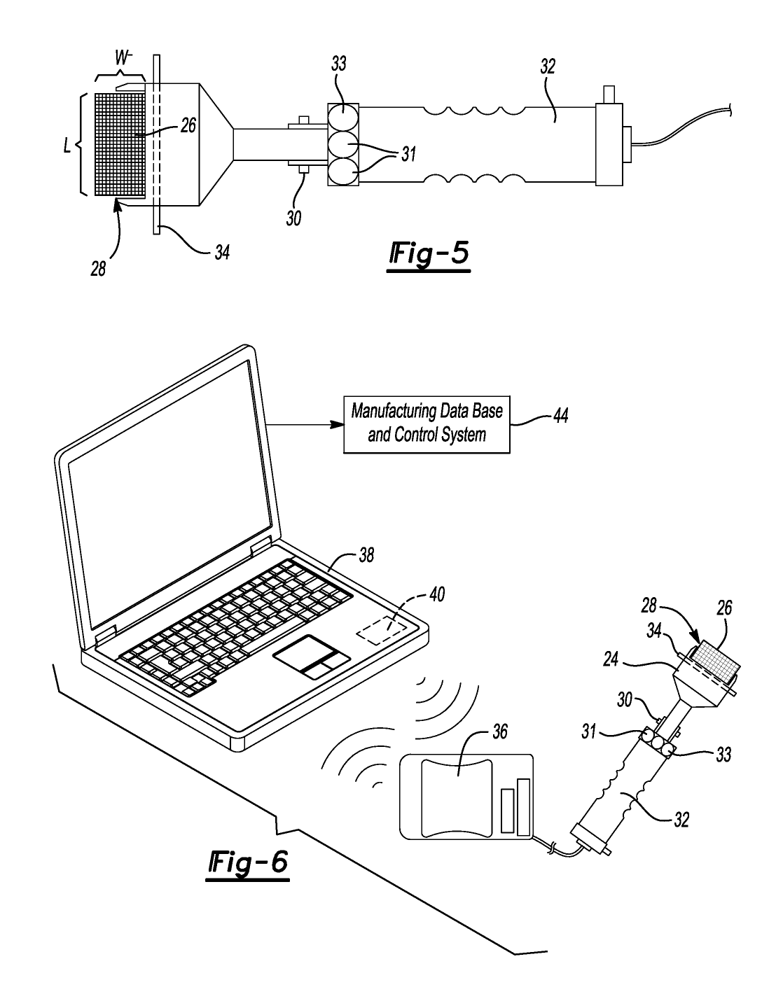

Sensor strip 28 shown in FIGS. 4 and 5 is part of the electronic strip pressure sensor 24. The sensor strip 28 includes a plurality of discreet pressure sensors 26 that are arrayed on the surface of the sensor strip 28. The sensor strip 28 has a thickness “T” of between 0.5 mils and 1.0 mils. The thin sensor strip allows the pressure applied to the seal to be measured without excessive distortion of the seal 22. The length “L” of the sensor strip 28 is approximately 50 millimeters and the width “W” of the sensor strip 28 is approximately 20 millimeters. The length “L” and width “W” of the sensor strip 28 corresponds to the length and width of the critical fit area determined as described with reference to FIG. 2 above.

An articulated joint 30, such as a pivot connector or ball joint, is provided between the electronic strip pressure sensor 24 and a handle 32. The handle 32 preferably includes circuitry for the electronic strip pressure sensor 24 and also includes on/off switches 31 and a measurement switch 33 for controlling operation of the electronic pressure sensor 24. A hard stop 34 is preferably provided on the pressure sensor 24 to control the extent of insertion of the pressure sensor 24 between seal 22 and the door opening 20. The hard stop 34 limits the extent of insertion to provide more consistent results and prevent inserting the pressure sensor 24 too far or insufficiently into the seal gap.

Referring to FIGS. 1, 6 and 7, the next step in the process indicated by reference numeral 35 is analyzing the pressure profile data measured by the pressure sensor 24. Referring to FIG. 6, the pressure profile data may be provided by a transmitter 36 operatively connected to the pressure sensor 24 to provide pressure data to a computer 38 that includes a receiver 40. The transmitter 36, as shown in FIG. 6, is a separate transmitter connected to the handle 32 of the pressure sensor 24. However, it should be understood that the transmitter 36 could be provided as an integral part of the pressure sensor 24.

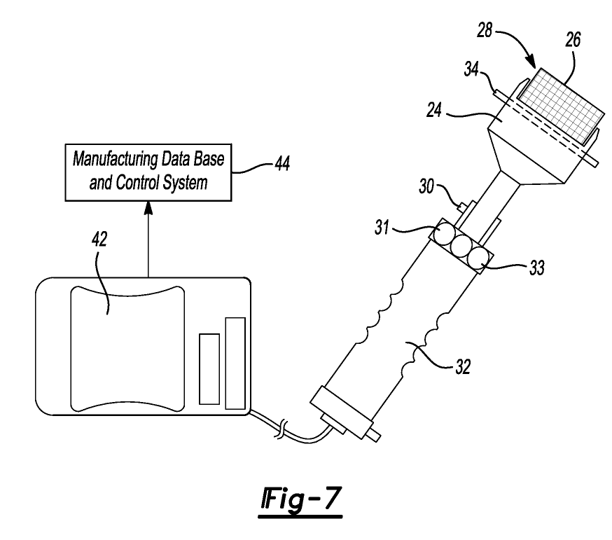

Referring to FIG. 7, in an alternative embodiment, the pressure sensor 24 may be connected to a data storage device 42 such as a flash drive or other storage medium. The data storage device 42 may be periodically downloaded to a manufacturing database and control system 44 as described below.

Referring to 1, 6 and 7, in the flowchart, a step of recording the pressure profile is indicated by reference numeral 43. The pressure profile may be recorded in a manufacturing database and control system 44 as indicated in FIGS. 6 and 7. The manufacturing database and control system 44 may record selected pressure reading based upon statistical process control techniques to select critical fit areas and record data for subsequent analysis. The data may be preserved as a part of the vehicle manufacturing record. In addition, the data may be used at 45 in FIG. 1 to make operational improvements as assembly operations proceed to identify potential problems that may occur on the manufacturing line for immediate correction. Alternatively, as also shown in FIG. 4, the step of making design improvements is indicated by reference numeral 47. Design improvements may be made by periodically or continuously as a result of communications with parts manufacturing sources to improve the design of a component part.

Data may be downloaded without requiring manual intervention to parts manufacturing sources, for launch operations, daily production environments or diagnostic studies. By selecting data on a statistically controlled basis, online pressure measurements may be taken within the cycle time available at a production station. The pressure sensor 24 can provide precise force and area of surface contact data and thereby provide an in-depth understanding of surface behavior to identify and eliminate potential quality control problems and continuously improve the manufacturing process. Measuring the contact pressure in critical fit areas facilitates eliminating wind noise and water leak problems in critical contact pressure areas.

The pressure sensor 24 eliminates the need to use handheld or digital calipers and significantly improves gauge reliability by eliminating operator-induced errors. Electronic pressure sensors 24 may include wireless or wired connections to allow data to be collected onto a data logger unit and uploaded to a data management system. The thin and flexible sensor 24 enables more precise and consistent analysis of surface contact and measurement of the seal gap.

The embodiments described above are specific examples that do not describe all possible forms of the disclosure. The features of the illustrated embodiments may be combined to form further embodiments of the disclosed concepts. The words used in the specification are words of description rather than limitation. The scope of the following claims is broader than the specifically disclosed embodiments and also includes modifications of the illustrated embodiments.

What is claimed is:

1. A method of assembling a closure member to a vehicle comprising:
identifying critical contact pressure areas between the closure member and an opening;
measuring pressure profile data across an area of surface contact with a strip shaped electronic sensor of a length “L” between the closure member and the opening; and
analyzing pressure profile data to create analytical data.

2. The method of claim 1 wherein an electronic sensor that is between 0.5 mils and 1.0 mils thick is used to measure the pressure profile across an area of surface contact.

3. The method of claim 1 wherein the electronic sensor is connected to a handle by an articulating joint, wherein an angular orientation of the sensor to the handle is adjusted to align the strip with a seal gap defined between the closure member and the door opening when the closure member is closed.

4. The method of claim 1 further comprising:
transmitting the pressure profile data for a plurality of critical fit areas to a data processing system; and
analyzing the pressure profile data for the plurality of critical fit areas.

5. The method of claim 1 further comprising:
storing the pressure profile data for a plurality of critical fit areas on a data storage device; and
downloading the pressure profile data from the data storage device to a data processing system; and
analyzing the pressure profile data for the plurality of critical fit areas.

6. The method of claim 1 wherein the step of measuring pressure profile data across an area of surface contact is performed on selected vehicles after assembly on an assembly line and the data is recorded in a database that collects manufacturing records associated with the vehicle.

7. A system for monitoring pressure around a vehicle closure member comprising:
an electronic sensor including a plurality of discrete pressure sensors on a membrane that create a profile of pressure data;
a data processor receiving and analyzing the profile of pressure data to identify areas of insufficient and excessive pressure; and
a data storage system for recording areas of insufficient and excessive pressure around the vehicle closure member.

8. The system of claim 7 further comprising:
a transmitter operatively connected to the electronic sensor that transmits the profile of pressure data; and
a receiver operatively connected to the data processor that receives the profile of pressure data.

9. The system of claim 7 further comprising:
a data storage device operatively connected to the electronic sensor that stores the pressure profile data; and
a terminal operatively connected to the data processor that downloads the pressure profile data to a data processing system.

10. The system of claim 7 wherein the electronic sensor is a planar electronic sensor, the system further comprising:
a handle attached to the planar electronic sensor by an articulated connector, wherein the planar electronic sensor is inserted into a seal gap defined between the closure member and an door opening defined by a vehicle to be closed by the closure member in a plurality of critical fit areas located at different locations around the closure member, wherein the planar electronic sensor is adjusted relative to the handle to be aligned with the seal gap at a selected critical fit area.

11. The system of claim 7 wherein the step of measuring the pressure profile data across an area of surface contact is performed at a randomly selected subset of selected critical fit areas on each vehicle assembled on an assembly line.

12. The system of claim 7 further comprising:
a database system that collects the profile of pressure data as a manufacturing record associated with the vehicle.
